(19) United States
(12) Patent Application Publication
(10) Pub. No.: US 2026/0274451 A1
(43) Pub. Date: Sep. 17, 2026

(54) ON-ORBIT DOCKING AND COUPLING DEVICE

(71) Applicant: KOREA AEROSPACE RESEARCH INSTITUTE, Daejeon (KR)

(72) Inventors: Eui Keun KIM, Daejeon (KR); Choon Woo LEE, Daejeon (KR)

(73) Assignee: KOREA AEROSPACE RESEARCH INSTITUTE, Daejeon (KR)

(21) Appl. No.: 19/404,729

(22) Filed: Dec. 1, 2025

(30) Foreign Application Priority Data
Mar. 12, 2025 (KR) 10-2025-0032156

(51) Int. Cl. B64G 1/64; B25J 15/10; B64G 1/10

(52) U.S. Cl. CPC B64G 1/6464; B25J 15/10; B64G 1/1078

(57) ABSTRACT

An on-orbit docking and coupling device according to one embodiment of the present invention is an on-orbit docking and coupling device of a servicing space object that connects to an interface of a client space object in outer space, wherein the interface includes a guide hole and a support groove, and the docking and coupling device is configured to include: a pair of first grippers that are movable in a direction in which they move away from or approach each other, and that can grip the interface by being inserted into the guide hole and then moving away from each other; and a pair of second grippers that are movable in a direction in which they move away from or approach each other, and that can grip the interface by being seated in the support groove while moving closer to each other.

### CROSS-REFERENCE TO RELATED APPLICATION

This application claims priority under 35 U.S.C. §119 to Korean Patent Application No. 10- 2025-0032156, filed in the Korean Intellectual Property Office on Mar. 12, 2025, the entire contents of which are hereby incorporated by reference.

### TECHNICAL FIELD

The present invention relates to an on-orbit docking and coupling device, and more particularly, to an on-orbit docking and coupling device (end effector) by which, during on-orbit servicing, a servicing space object can dock with a client space object stably and efficiently.

### BACKGROUND

Providing services such as condition inspection, orbital towing and transfer, refueling, repair, and component replacement for space objects such as artificial satellites in outer space is called On-Orbit Servicing (OOS). Such on-orbit servicing has been drawing attention as one of the innovative technologies in space since it deals with servicing space objects in outer space.

As a related technology, techniques such as the proximity operation and docking mechanism of a servicing space object (servicing satellite) equipped with a robotic arm having an end effector toward a client space object (client satellite) are required.

FIG. 1 illustrates an example of a conventional on-orbit docking and coupling device. In FIG. 1, reference numeral 700 denotes an end effector attached to a robotic arm of a servicing space object, and reference numeral 900 denotes a mechanical interface of a client space object.

However, such a conventional docking and coupling device allows the end effector of the servicing space object to grip the interface of the client space object by a simple gripper, in which the refueling lines of the servicing space object and the client space object are aligned during the gripping process.

However, because the simple gripper directly grasps the target interface, there is a high possibility of an initial misalignment, and if the interface is not properly aligned, coupling may fail or require additional adjustment.

Furthermore, when the gripper grasps the target interface, an asymmetric force may act on the target object equipped with the interface, causing unintended movement or rotation of the interface, which may reduce coupling accuracy or cause damage.

### SUMMARY

The present invention has been made to solve the problems of the prior art as described above, and an object of the present invention is to provide an on-orbit docking and coupling device by which a servicing space object can stably and efficiently dock with a client space object when docking.

In order to achieve the above object, an on-orbit docking and coupling device according to one embodiment of the present invention is an on-orbit docking and coupling device of a servicing space object that connects to an interface of a client space object in outer space, wherein the interface includes a guide hole and a support groove, and the docking and coupling device is configured to include: a pair of first grippers that are movable in a direction in which they move away from or approach each other, and that can grip the interface by being inserted into the guide hole and then moving away from each other; and a pair of second grippers that are movable in a direction in which they move away from or approach each other, and that can grip the interface by being seated in the support groove while moving closer to each other.

In addition, the length of the guide hole is longer than the length of the support groove, and the first grippers are formed longer than the second grippers so as to simultaneously perform the functions of a guide bar and an alignment auxiliary.

In addition, an inner wall groove in which the first grippers can be inserted and supported is formed on an inner wall of the guide hole.

In addition, each first gripper includes a first gripper proximal end portion mounted on a coupling device body portion of the docking and coupling device, a first gripper intermediate portion extending from the proximal end portion and bent inwardly toward the inside of the coupling device body portion, and a first gripper distal end portion extending from the first gripper intermediate portion and capable of being positioned in the inner wall groove.

In addition, the support groove becomes gradually narrower toward a proximal end side.

In addition, the interface includes a first interface portion that is gripped by the first and second grippers, a second interface portion that is coupled to the first interface portion and is movable relative thereto, and an elastic member connecting the first and second interface portions to each other.

In addition, the second interface portion includes a detachment prevention portion for preventing detachment of the first interface portion.

In addition, the interface portion includes a first connection line, and the docking and coupling device includes a second connection line that can be connected to and communicate with the first connection line.

A method for connecting to the interface using the above-described on-orbit docking and coupling device includes the steps of: inserting the pair of first grippers into the guide hole; moving the pair of first grippers away from each other in a state inserted into the guide hole so that the first grippers are supported by the inner wall groove of the guide hole; and moving the pair of second grippers toward each other to be seated in the support groove.

The on-orbit docking and coupling device according to the embodiment of the present invention having the above-described configuration provides the following effects.

During docking between a client space object and a servicing space object, a pair of relatively long first grippers perform a guide bar function while fixing the client space object and the servicing space object to each other, and subsequently, by gripping the client space object with a pair of relatively short second grippers, docking and coupling can be easily achieved in the space environment.

In addition, it provides a guide and gripping structure for the servicing space object to approach the client space object in outer space and to stably and efficiently perform docking, alignment, and coupling.

Meanwhile, although not explicitly described, the present invention of course also includes other effects that can be expected from the above-described configuration.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings.

FIG. 1 is an example of a conventional on-orbit docking and coupling device.

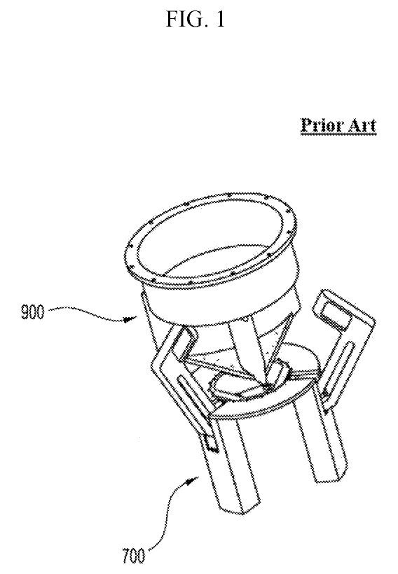

FIG. 2 shows a state in which an on-orbit docking and coupling device of a servicing space object according to one embodiment of the present invention and an interface of a client space object are separated from each other.

FIG. 3 is a view of FIG. 2 seen from another direction.

FIGS. 4A and 4B show the interface of the client space object of FIG. 2.

FIG. 5A is a side view of the interface of FIG. 4B, and FIG. 5B is a cross-sectional view thereof.

FIG. 6 is a cross-sectional view comparing the length of the guide hole and the length of the support groove in the interface of FIG. 4.

FIG. 7 is a perspective view of the docking coupling device of the servicing space object of FIG. 2.

FIG. 8 is a plan view of the docking and coupling device of FIG. 7.

FIG. 9 shows a state in which the grippers of the servicing space object are inserted into the guide holes of the client space object in order for the servicing space object of FIG. 2 to dock with the client space object.

FIGS. 10A and 10B show a state in which, in the process of docking the servicing space object of FIG. 2 with the client space object, the grippers of the servicing space object are inserted into the guide holes of the client space object and spread apart to be supported by the inner wall grooves of the guide holes.

### DETAILED DESCRIPTION

Hereinafter, embodiments of the present invention will be described in detail with reference to the accompanying drawings so that those skilled in the art to which the present invention pertains can carry out the invention. However, the present invention may be implemented in various different forms, and is not limited to the embodiments described herein. In addition, the terms "first" and "second" used in this specification do not indicate an order, but are used to distinguish elements having the same name from each other. Meanwhile, in the present embodiment, as an example, the description is made on the case where the refueling lines of a client space object and a servicing space object are connected to each other for fuel refueling. However, the present invention is not limited thereto and may be used for various purposes within the scope of the technical idea of the present invention.

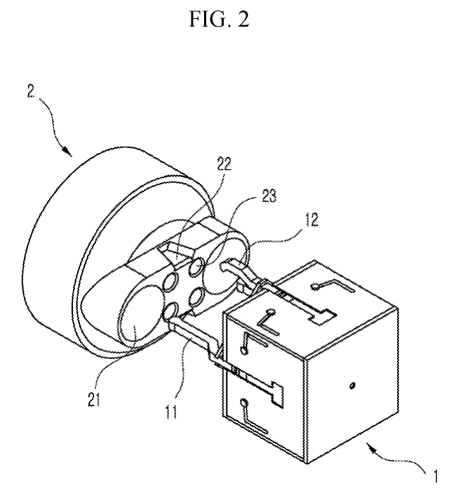

FIG. 2 shows an on-orbit docking and coupling device according to one embodiment of the present invention.

An on-orbit docking and coupling device 1 according to one embodiment of the present invention may be an on-orbit docking and coupling device 1 of a servicing space object that connects to an interface 2 of a client space object in outer space to refuel. Here, the interface 2 of the client space object includes a guide hole 21, a support groove 22, and a first fuel line (first connection line) 23.

Meanwhile, as the space object in this embodiment, various objects that operate in outer space, such as artificial satellites, space stations, or upper stages of rockets, may correspond thereto.

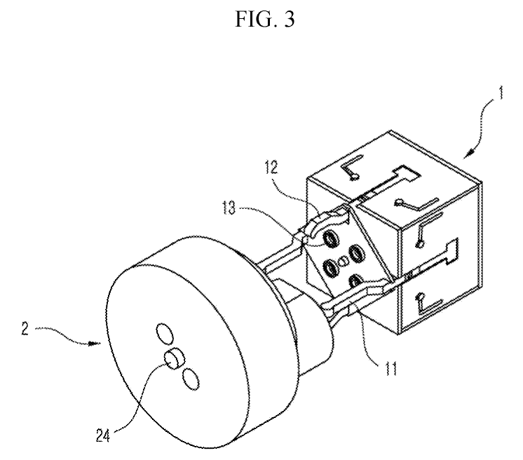

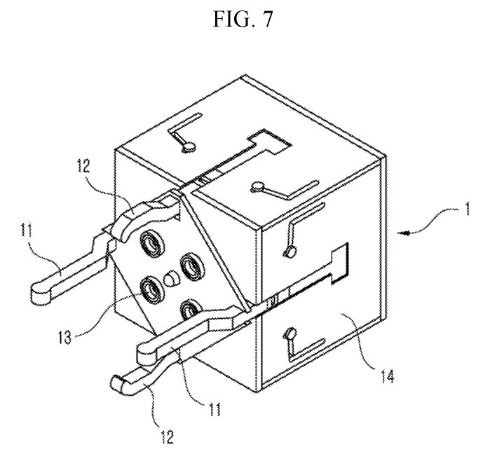

As shown in FIGS. 3 and 7, the on-orbit docking and coupling device 1 of the present invention includes a pair of first grippers 11, a pair of second grippers 12, and a second fuel line (second connection line) 13.

The pair of first grippers 11 are movable in a direction in which they move away from (spread apart) or approach (come together) each other, and after being inserted into the guide hole 21, they can grip the interface 2 by moving away from each other.

Also, the pair of second grippers 12 are movable in a direction in which they move away from or approach each other, and they can grip the interface 2 by being seated in the support groove 22 while moving closer to each other.

The second fuel line 13 is disposed at a position where it can be connected to and communicate with the first fuel line 23 when docking between the servicing space object and the client space object is completed.

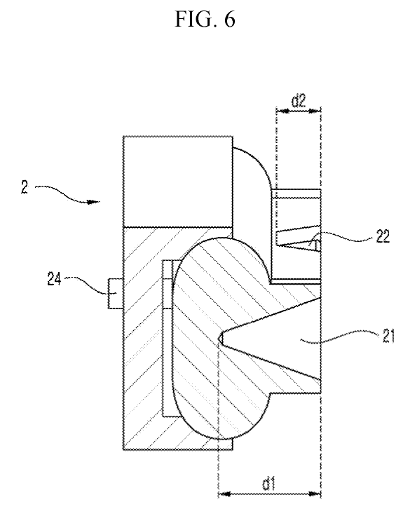

As shown in FIG. 6, in the client space object 2, the length (d1) of the guide hole 21 is longer than the length (d2) of the support groove 22. In this regard, the first grippers 11 are characterized in that they are longer than the second grippers 12.

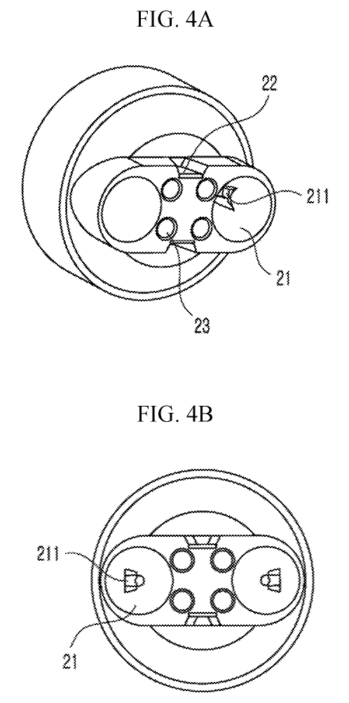

As shown in FIGS. 4A and 4B, an inner wall groove 211, into which the first grippers 11 can be inserted and supported, is formed on the inner wall of the guide hole 21.

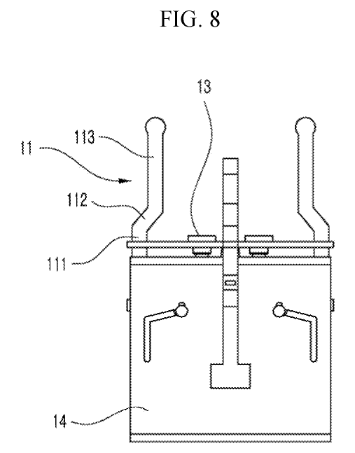

As shown in FIG. 8, each first gripper 11 includes a first gripper proximal end portion 111 mounted on a coupling device body portion 14 of the docking and coupling device 1, a first gripper intermediate portion 112 extending from the first gripper proximal end portion 111 and bent inward toward the inside of the coupling device body portion 14, and a first gripper distal end portion 113 extending from the first gripper intermediate portion 112 and capable of being positioned in the inner wall groove 211.

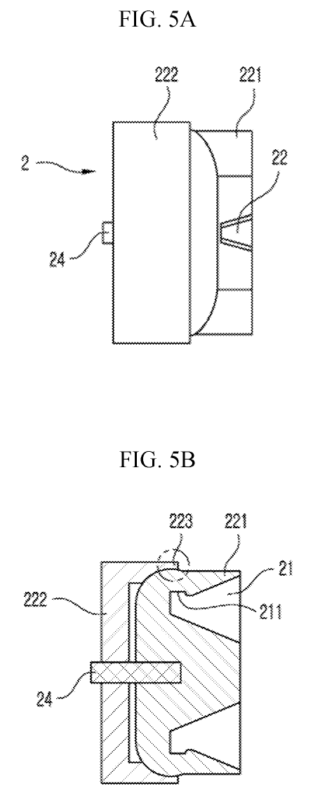

As shown in FIGS. 5A and 5B, the support groove 22 of the client space object becomes gradually narrower in width (length in the vertical direction in FIG. 5A) toward the proximal end (left side in FIG. 5A).

The interface 2 of the client space object includes a first interface portion 221, a second interface portion 222, and an elastic member 24.

The first interface portion 221 is directly gripped by the first and second grippers 11 and 12.

The first interface portion 221 is coupled to the second interface portion 222 so as to be movable relative thereto. In this regard, the second interface portion 222 may include a detachment prevention portion 223 for preventing detachment of the first interface portion 221.

The elastic member 24 may, by way of example, be a cylindrical bar, and connects the first interface portion 221 and the second interface portion 222 to each other. By this, when docking between the client space object and the servicing space object, the first interface portion 221, which is in direct contact with the grippers 11 and 12 of the servicing space object for shock mitigation, is allowed to have a certain relative movement with respect to the second interface portion 222, and the first interface portion 221 can return to its original coupled state with the second interface portion 222 by the restoring force of the elastic member 24.

Hereinafter, the operation of the on-orbit docking and coupling device according to one embodiment of the present invention having the above-described configuration will be described. By way of example, a case of docking and coupling for the purpose of fuel refueling will be described.

First, as shown in FIGS. 2 and 3, in order to refuel the client space object in outer space, the servicing space object approaches the client space object.

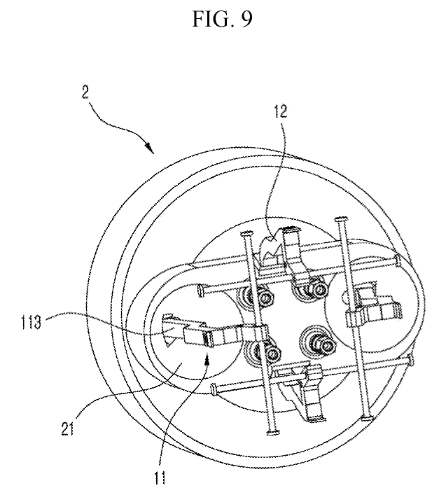

Next, as shown in FIG. 9, the pair of first grippers 11 of the servicing space object are inserted into the guide holes 21 of the client space object so that the client space object and the servicing space object are aligned in a primary alignment. For reference, in FIG. 9, for convenience of explanation, only the grippers 11 and 12 of the servicing space object are illustrated, and the remaining components are omitted.

Next, in a state where the pair of first grippers 11 are inserted into the respective guide holes 21, the pair of first grippers 11 are moved in directions away from each other so that the first grippers 11 are inserted into and supported (fixed) by the inner wall grooves 211 of the guide holes 21. Specifically, the distal end portions 113 of the first grippers are supported by the inner wall grooves 211 of the guide holes 21 so that the client space object and the servicing space object are aligned in a secondary alignment. In this way, during docking, the first grippers 11 perform both the guide bar function and the fixing function simultaneously.

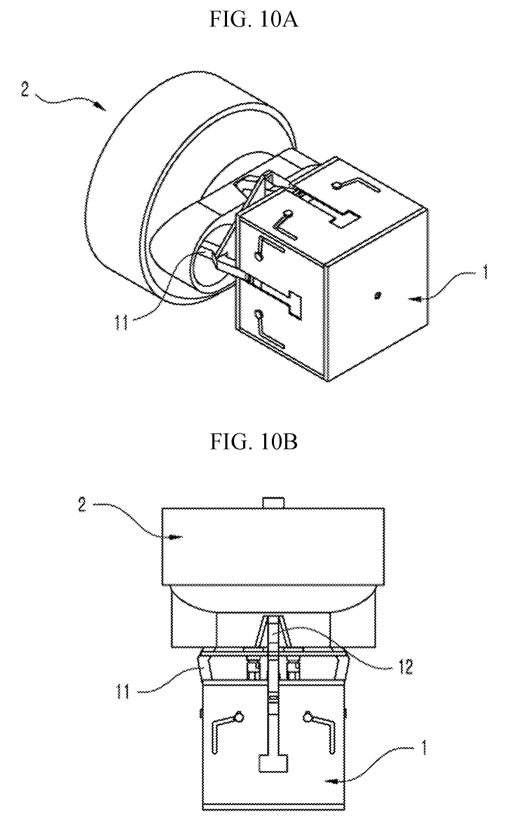

Next, the pair of second grippers 12 of the servicing space object are moved toward each other and are seated in the support grooves 22 of the client space object to grip the client space object, thereby completing the docking (see FIGS. 10A and 10B). For reference, when the first grippers 11 are inserted into the inner wall grooves 211 of the guide holes 21, the second grippers 12 can also be guided along the support grooves 22. As described above, since the support grooves 22 are formed so that the width gradually decreases from the distal end side toward the proximal end side, the first grippers 11 can be guided to desired final positions and easily arranged.

As the docking between the client space object and the servicing space object is completed in this manner, the first fuel line 23 of the client space object and the second fuel line 13 of the servicing space object can be connected to each other.

Although the preferred embodiments of the present invention have been described in detail above, the scope of the present invention is not limited thereto, and various modifications and improvements made by those skilled in the art using the basic concept of the present invention defined in the following claims are also within the scope of the present invention.

1. An on-orbit docking and coupling device of a servicing space object that connects to an interface of a client space object in outer space, wherein the interface includes a guide hole and a support groove, and the docking and coupling device includes:
a pair of first grippers that are movable in a direction in which they move away from or approach each other, and that can grip the interface by being inserted into the guide hole and then moving away from each other; and
a pair of second grippers that are movable in a direction in which they move away from or approach each other, and that can grip the interface by being seated in the support groove while moving closer to each other.

2. The on-orbit docking and coupling device according to claim 1,
wherein the length of the guide hole is longer than the length of the support groove, so as to simultaneously perform the functions of a guide bar and an alignment auxiliary.

3. The on-orbit docking and coupling device according to claim 1,
wherein an inner wall groove into which the first grippers can be inserted and supported is formed on an inner wall of the guide hole.

4. The on-orbit docking and coupling device according to claim 3,
wherein each first gripper includes:
a first gripper proximal end portion mounted on a coupling device body portion of the docking and coupling device;
a first gripper intermediate portion extending from the first gripper proximal end portion and bent inward toward the inside of the coupling device body portion; and
a first gripper distal end portion extending from the first gripper intermediate portion and capable of being positioned in the inner wall groove.

5. The on-orbit docking and coupling device according to claim 2,
wherein the support groove becomes gradually narrower toward a proximal end side.

6. The on-orbit docking and coupling device according to claim 1,
wherein the interface includes:
a first interface portion that is gripped by the first and second grippers;
a second interface portion that is coupled to the first interface portion so as to be movable relative thereto; and
an elastic member connecting the first and second interface portions to each other.

7. The on-orbit docking and coupling device according to claim 6,
wherein the second interface portion includes a detachment prevention portion for preventing detachment of the first interface portion.

8. The on-orbit docking and coupling device according to claim 1,
wherein the interface portion includes a first connection line, and the docking and coupling device includes a second connection line that can be connected to and communicate with the first connection line.

9. A method for docking and coupling to the interface using the on-orbit docking and coupling device according to claim 1, comprising:
inserting the pair of first grippers into the guide hole;
moving the pair of first grippers away from each other in a state inserted into the guide hole so that the first grippers are supported by the inner wall groove of the guide hole; and
moving the pair of second grippers toward each other to be seated in the support groove.
